(19) United States
(12) Patent Application Publication
(10) Pub. No.: US 2016/0164061 A1
(43) Pub. Date: Jun. 9, 2016

(54) BATTERY MODULE

(71) Applicant: Samsung SDI Co., Ltd., Yongin-si (KR)

(72) Inventors: Min-Yeol Han, Yongin-si (KR); Haekwon Yoon, Yongin-si (KR); Jaekyung Kim, Yongin-si (KR); Yonghee Yun, Yongin-si (KR); Seungbok Lee, Yongin-si (KR)

(21) Appl. No.: 14/964,419

(22) Filed: Dec. 9, 2015

(30) Foreign Application Priority Data
Dec. 9, 2014 (KR) 10-2014-0175881

(51) Int. Cl. H01M 2/18; H01M 10/6557

(52) U.S. Cl. CPC H01M 2/18; H01M 10/6557

(57) ABSTRACT

Provided is a battery module. The battery module includes: battery cells arranged in a first direction; a spacer disposed between neighboring battery cells; and a center pin extending in a second direction that is different from the first direction and inserted through the spacer to cross the spacer. Therefore, the battery module effectively absorbs external pressure or internal pressure caused by swelling and thus has a sufficient degree of stiffness against internal or external pressure. In addition, the battery module has a heat-dissipating structure for effectively dissipating heat generated during charging and discharging operations.

### RELATED APPLICATIONS

This application claims the benefit of Korean Patent Application No. 10-2014-0175881, filed on Dec. 9, 2014, in the Korean Intellectual Property Office, the disclosure of which is incorporated herein in its entirety by reference.

### BACKGROUND

1. Field

One or more exemplary embodiments relate to a battery module.

2. Description of the Related Art

Unlike primary batteries, secondary batteries are rechargeable. Secondary batteries are used as energy sources of devices such as mobile devices, electric vehicles, hybrid electric vehicles, electric bicycles, and uninterruptible power supplies. Single-cell secondary batteries or multi-cell secondary batteries (secondary battery modules) in which a plurality of battery cells are electrically connected together and are used according to the types of external devices using the secondary batteries.

### SUMMARY

One or more exemplary embodiments include a battery module capable of effectively absorbing external pressure or internal pressure caused by swelling and thus having a sufficient degree of stiffness against internal or external pressure.

One or more exemplary embodiments include a battery module having a heat-dissipating structure for effectively dissipating heat generated during charging and discharging operations.

Additional aspects will be set forth in part in the description which follows and, in part, will be apparent from the description, or may be learned by practice of the presented embodiments.

According to one or more exemplary embodiments, a battery module includes: battery cells arranged in a first direction; a spacer disposed between neighboring battery cells; and a center pin extending in a second direction that is different from the first direction and inserted through the spacer to cross the spacer.

The spacer may have a waveform pattern in which a plurality of convex or concave shapes are repeatedly arranged.

The spacer may have a triangular waveform pattern.

The second direction may be perpendicular to the first direction.

The spacer may be formed of an elastic material.

The spacer may be formed of a metallic material.

The spacer may be elastically deformed while being spread in the second direction in response to a compressing force applied in the first direction, so as to absorb the compressing force applied in the first direction.

The center pin may be a hollow member in which a flow passage is formed for a cooling medium.

The spacer may have a hollow circular cross-section.

The center pin may include a pair of pins extending in parallel with each other.

Stopping jaws may be formed on both ends of the center pin to prevent separation of the spacer from the center pin.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is an exploded perspective view illustrating a battery module according to an exemplary embodiment;

FIG. 2 is a view illustrating an assembled state of the battery module illustrated in FIG. 1;

FIG. 3 is an exploded perspective view illustrating some elements of the battery module illustrated in FIG. 1;

FIG. 4 is a schematic view illustrating an operation of a center pin;

FIGS. 5A and 5B are views illustrating an initially assembled state in which a pressure is not applied to a spacer and a compressed state in which a pressure is applied to the spacer;

FIG. 6 is a cross-sectional view illustrating a center pin; and

FIG. 7 is an exploded perspective view illustrating an arrangement of spacers according to another exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items.

Hereinafter, battery modules will be described in detail with reference to the accompanying drawings, in which exemplary embodiments are shown.

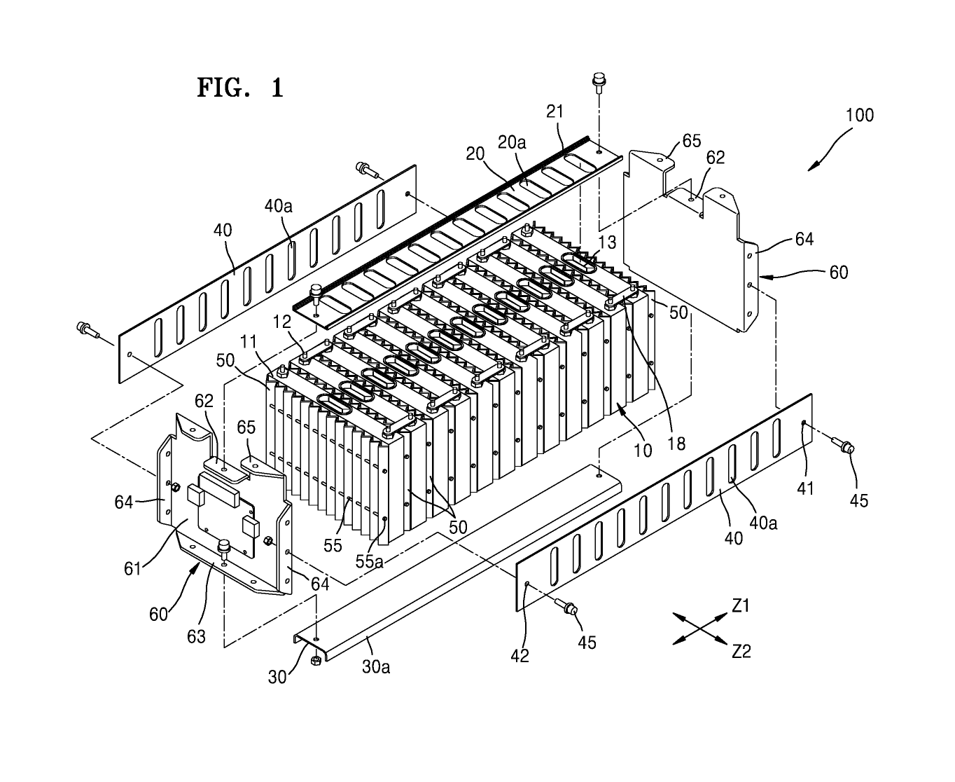

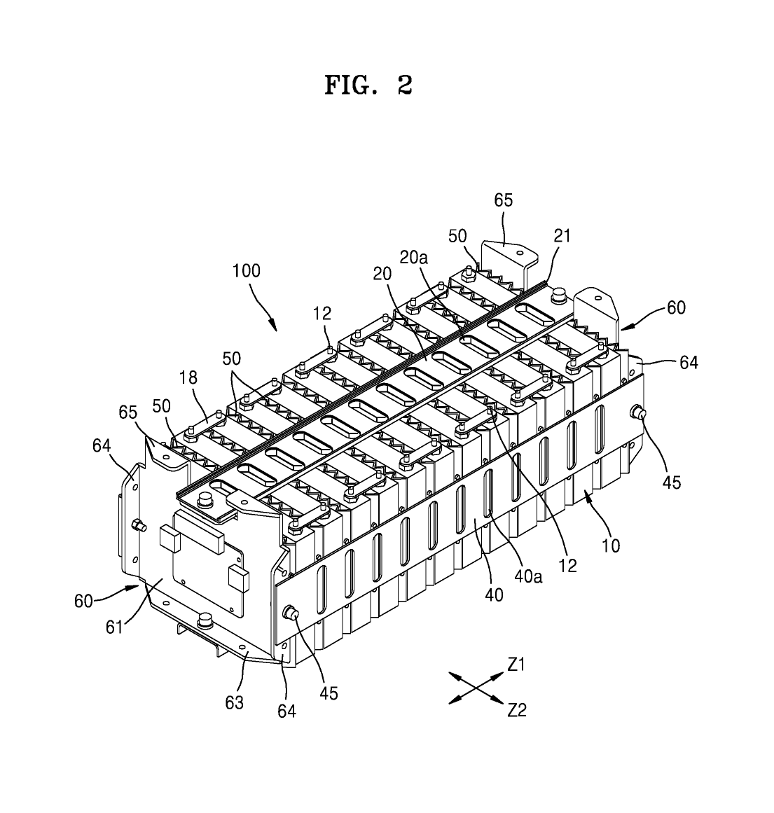

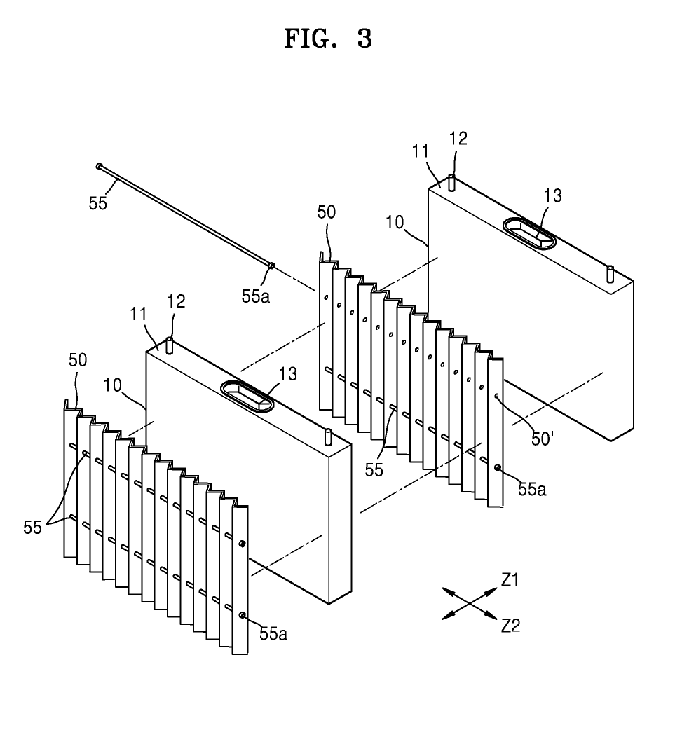

FIG. 1 is an exploded perspective view illustrating a battery module 100 according to an exemplary embodiment. FIG. 2 is a view illustrating an assembled state of the battery module 100 illustrated in FIG. 1. FIG. 3 is an exploded perspective view illustrating some elements of the battery module 100 illustrated in FIG. 1.

Referring to FIG. 1, the battery module 100 includes a plurality of battery cells 10 arranged in a first direction Z1, and upper, lower, side, and end plates 20, 30, 40, and 60 surrounding the battery cells 10. For example, the battery cells 10 may be arranged as an array in the first direction Z1, and the battery module 100 may include a single array or stacked multiple arrays of such battery cells 10.

The battery cells 10 may be secondary battery cells such as lithium ion battery cells. The battery cells 10 may have any shape such as a cylindrical shape or a prismatic shape. In addition, the battery cells 10 may be any type of battery cells such as polymer battery cells. That is, the battery cells 10 are not limited to a particular shape or type.

For example, each of the battery cells 10 may include a case 11, an electrode assembly (not shown) disposed in the case 11, and electrode terminals 12 electrically connected to the electrode assembly and exposed to the outside of the case 11. For example, the electrode terminals 12 may be exposed to the outside of the case 11 and may form portions of an upper side of the case 11. Although not shown, the electrode assembly may include a positive electrode plate, a separator, and a negative electrode plate. The electrode assembly may be a jelly-roll or stacked type electrode assembly. The case 11 accommodates the electrode assembly, and the electrode terminals 12 are exposed to the outside of the case 11 for electric connection with an external circuit (not shown).

Neighboring battery cells 10 may be electrically connected to each other by connecting electrode terminals 12 of the neighboring battery cells 10. In detail, neighboring battery cells 10 may be electrically connected in series or parallel to each other by connecting electrode terminals 12 of the neighboring battery cells 10 using bus bars 18.

A safety vent 13 may be formed in the case 11. The safety vent 13 is relative weak so that if the inside pressure of the case 11 increases to a critical value or higher, the safety vent 13 may be fractured to release gas from the inside of the case 11.

The end plates 60 are provided as a pair on both ends of the battery cells 10 in an arrangement direction (the first direction Z1) of the battery cells 10. Sides of the end plates 60 face outermost battery cells 10. The end plates 60 combine the battery cells 10 as a unit. During charging and discharging of the battery cells 10, the end plates 60 prevent or at least inhibit expansion of the battery cells 10 and maintain resistance characteristics of the battery cells 10, thereby preventing deterioration of the electric characteristics of the battery cells 10.

Each of the end plates 60 includes a base plate 61 and flanges 62, 63, 64, and 65 bent from edges of the base plate 61. The base plate 61 may have a sufficient area to cover a corresponding side of the battery cells 10.

The flanges 62, 63, 64, and 65 are bent from the edges of the base plate 61 in a direction opposite the battery cells 10. In this case, the flanges 62, 63, 64, and 65 may be formed by bending and/or cutting edge portions of the base plate 61. For example, the flanges 63 and 64 are formed by bending lower, left, and right edge portions of the base plate 61 without cutting, and the flanges 62 and 65 are formed by cutting an upper edge portion of the base plate 61 and separately bending cut portions of the upper edge portion at different heights. The flanges 62, 63, 64, and 65 may function as coupling structures between the end plate 60 and another member, and thus may be variously modified according to the coupling structure between the end plate 60 and another member. In addition, the flanges 62, 63, 64, and 65 enhance the mechanical stiffness of the end plate 60. A plurality of coupling holes may be formed in the flanges 62, 63, 64, and 65.

One end plate 60 is coupled to the other end plate 60 through the side plates 40. That is, the side plates 40 combine the end plates 60 as a pair. The side plates 40 extend along lateral sides of the battery cells 10. Ends of the side plates 40 are coupled to one of the end plates 60, and the other ends of the side plates 40 are coupled to the other of the end plates 60. The side plates 40 may be band-shaped strips extending in one direction. Coupling holes 41 and 42 are formed in both end portions of the side plates 40, and the flanges 64 bent from the left and right edges of the end plates 60 may be coupled to the side plates 40 by inserting screws in the coupling holes 41 and 42. For example, after overlapping the side plates 40 and the flanges 64, coupling members 45 may be coupled to the coupling holes 41 and 42. For example, bolts may be inserted in the coupling holes 41 and 42, and nuts may be coupled to the bolts for coupling the side plates 40 and the flanges 64.

Heat-dissipating holes 40a may be formed in the side plates 40. For example, the heat-dissipating holes 40a may be arranged at regular intervals in the length direction of the side plates 40. Air may flow to the battery cells 10 through the heat-dissipating holes 40a, and thus heat may be rapidly dissipated from the battery cells 10 during operation of the battery cells 10.

The lower plate 30 is disposed on a lower side of the battery cells 10. The lower plate 30 extends across the lower side of the battery cells 10 and is connected to lower portions of the end plates 60. The lower plate 30 may be a strip including bent portions 30a formed by bending both sides of the strip to face each other. The lower plate 30 may support the weight of the battery module 100 including the battery cells 10, and owing to the bent portions 30a, the bending strength of the lower plate 30 may be improved.

The lower plate 30 may be coupled to the flanges 63 bent from lower edges of the end plates 60 by placing the flanges 63 on the lower plate 30, aligning coupling holes of the flanges 63 and the lower plate 30, and fastening the flanges 63 and the lower plate 30 using fasteners such as bolts and nuts.

The upper plate 20 is disposed on an upper side of the battery cells 10. The upper plate 20 extends across the upper side of the battery cells 10 and is connected to upper portions of the end plates 60. The upper plate 20 may be a strip including bent portions 21 formed by bending both sides of the strip to face each other. Openings 20a may be arranged in the length direction of the upper plate 20 at positions corresponding to the positions of the safety vents 13 of the battery cells 10. The upper plate 20 may be coupled to the flanges 62 bent from upper edges of the end plates 60 by placing the flanges 62 on the upper plate 20, aligning coupling holes of the flanges 62 and the upper plate 20, and fastening the flanges 62 and the upper plate 20 using fasteners such as bolts and nuts.

Spacers 50 are disposed between the battery cells 10 neighboring each other. The spacers 50 may be disposed between the neighboring battery cells 10 for absorbing pressure between the neighboring battery cells 10. For example, the spacers 50 may absorb pressure between the neighboring battery cells 10 when the battery cells 10 are impacted or swell during charging and discharging operations.

For example, the spacers 50 may be elastically deformed while being spread in a direction different from the first direction Z1, for example, in a second direction Z2 perpendicular to the first direction Z1 in response to a compressing force applied in the arrangement direction (the first direction Z1) of the battery cells 10, and thus the compressing force applied in the first direction Z1 may be absorbed by the spacers 50.

In more detail, if the battery module 100 is pressed in the first direction Z1 by external pressure applied to the battery module 100, the spacers 50 may absorb most compressive strain of the battery module 100, that is, most pressure or deformation in the battery module 100. For example, in a compression test for evaluating the safety of the battery module 100 against deformation, the spacers 50 may absorb most pressure applied to the battery module 100 while absorbing most deformation of the battery module 100.

For example, the spacers 50 may be elastically deformed while being spread in a direction different from the first direction Z1, for example, in the second direction Z2 perpendicular to the first direction Z1 in response to a longitudinal compressing force or deformation applied in the arrangement direction (the first direction Z1) of the battery cells 10, so as to effectively absorb the longitudinal compressing force or deformation applied in the first direction Z1 of the battery module 100. Elastic deformation of the spacers 50 will be described later in more detail.

In addition, during charging and discharging operations of the battery cells 10, the spacers 50 may absorb swelling of the battery cells 10 (that is, pressure or expansion of the battery cells 10 neighboring each other) so as to reduce pressure of the battery cells 10. This will now be described in more detail.

When the battery cells 10 swell or expand during charging and discharging operations, the spacers 50 function as buffers absorbing the swelling or expansion of the battery cells 10. For example, when the battery cells 10 expand and change in shape, the spacers 50 may be flexibly and elastically deformed between the battery cells 10, and thus the battery cells 10 may not be excessively compressed. That is, the spacers 50 may absorb expansion of the battery cells 10 and maintain pressure between the battery cells 10 at a substantially constant level. If pressure between the battery cells 10 is excessively high above a proper level, the possibility of safety accidents such as explosions may increase.

For example, the spacers 50 may have a waveform pattern in which a plurality of convex shapes (or concave shapes) are repeatedly arranged so that the spacers 50 may be flexibly and elastically deformed while being spread or contracted in the second direction Z2 according to expansion or contraction of the battery cells 10 neighboring each other. In this case, the second direction Z2 in which the spacers 50 tend to spread or contract may be perpendicular to the arrangement direction (the first direction Z1) of the battery cells 10.

When the spacers 50 are elastically deformed while being spread or contracted, the distance between the convex shapes of the spacers 50 may be increased or decreased. In this case, however, the total lengths of the spacers 50 may not be necessarily increased or decreased.

As described later, the total lengths of the spacers 50 may be determined by center pins 55 inserted through the spacers 50. For example, stopping jaws 55a or similar flanged surfaces formed on both ends of the center pins 55 may determine maximal deformation lengths of the spacers 50, and in this state in which the maximal deformation lengths of the spacers 50 are limited by the stopping jaws 55a, the spacers 50 may contract in the first direction Z1 to absorb expansion of the battery cells 10 in the first direction Z1 and may return to original shapes by resilience thereof when the battery cells 10 contract into original shapes thereof.

When the battery module 100 is initially assembled, the spacers 50 may be in a relatively relaxed state without tension (there may be clearances between the spacers 50 and the stopping jaws 55a), and if the battery cells 10 swell during charging and discharging operations, the spacers 50 may be deformed while being contracted between the battery cells 10 (there may be little or no clearance between the spacers 50 and the stopping jaws 55a, and the spacers 50 may be elastically deformed and held against the stopping jaws 55a).

In the exemplary embodiment, the spacers 50 may have a triangular waveform pattern in which triangular wedge shapes are repeatedly arranged in the second direction Z2. However, the exemplary embodiments of the present disclosure are not limited thereto. For example, the spacers 50 may have a rounded water or sinusoid waveform pattern.

The spacers 50 may be formed of an elastic material so as to be elastically deformed according to pressure applied thereto or expansion of the battery cells 10. For example, the spacers 50 may be formed of a metallic material having a proper elastic modulus in consideration of swelling of the battery cells 10 or the amount of elastic force to be applied to the battery cells 10. For example, the spacers 50 may be formed of an aluminum material which is light and has a proper elastic modulus. As described later, the spacers 50 may function as heat-dissipating structures. Thus, the spacers 50 may be formed of a metallic material having a high degree of thermal conductivity so as to provide improved heat-dissipating structures. However, in the current exemplary embodiment, materials that may be used to form the spacers 50 are not limited.

The spacers 50 may provide heat-dissipating passages between the battery cells 10. In detail, the spacers 50 may have a waveform pattern in which a plurality of convex shapes (or concave shapes) are repeatedly arranged, and thus a plurality of empty spaces may be formed between the battery cells 10 owing to the spacers 50. The spaces may function as clearances allowing elastic deformation of the spacers 50 and as passages through which ambient air having a relatively low temperature flows as a cooling medium between the battery cells 10.

During charging and discharging operations of the battery cells 10, heat accumulated in the battery cells 10 may cause swelling of the battery cells 10. Therefore, if the spacers 50 including a plurality of convex shapes provide cooling medium flow spaces between the battery cells 10, the battery cells 10 may be more easily cooled, and thus swelling of the battery cells 10 may be prevented or reduced.

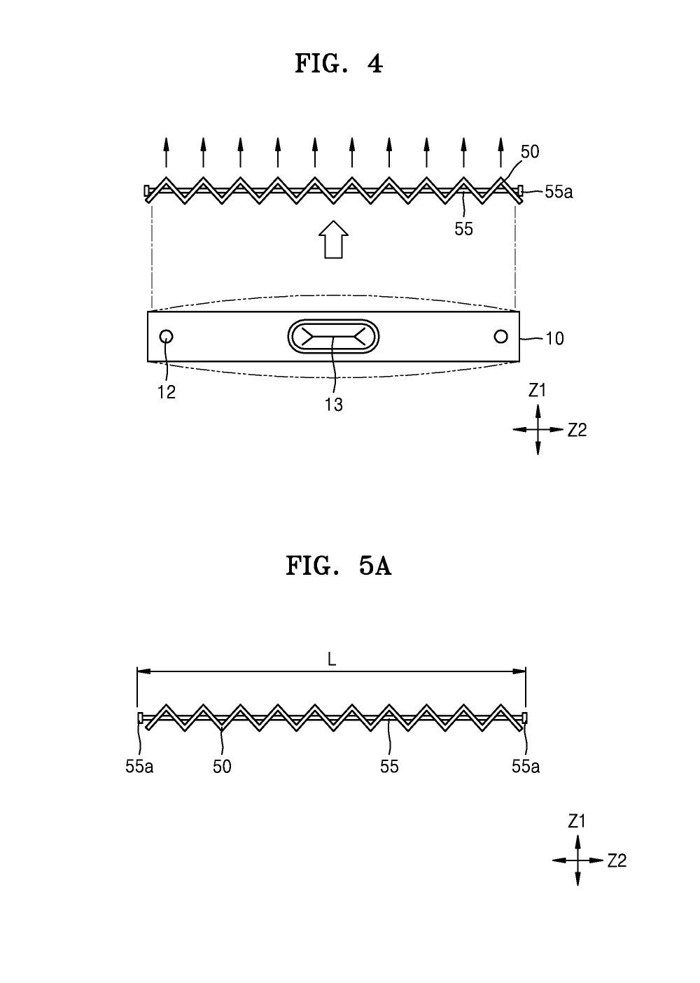

The center pins 55 are inserted in the spacers 50 in such a manner that the center pins 55 may extend through the spacers 50 in the second direction Z2. As shown in FIG. 4, owing to the center pins 55 (one shown in FIG. 4), pressure acting on the battery cells 10 may be more uniformly distributed. For example, when the battery cells 10 swell, center portions of the battery cell 10 neighboring each other may be curved the most, and thus the highest pressure may be applied between the center portions of the battery cells 10.

In this case, owing to the center pins 55, the highest pressure may be easily distributed from the center portions to the entire regions of the spacers 50 in the second direction Z2. The center pins 55 extending in the second direction Z2 may more uniformly distribute a locally concentrated pressure to the entire regions of the spacers 50 in the second direction Z2 and may induce the spacers 50 to be more uniformly and elastically deformed in the second direction Z2. That is, although pressure is locally applied, the entire regions of the spacers 50 may be more uniformly deformed, and thus expansion of the battery cells 10 may be absorbed more effectively.

For example, if only center portions of the spacers 50 are locally deformed, expansion of the battery cells 10 may not be further absorbed after the convex shapes of the center portions of the spacers 50 are fully deformed. However, since the center pins 55 induce uniform deformation of the spacers 50, expansion of the battery cells 10 may be absorbed more effectively. For example, in a compression test for evaluating the safety of battery modules, a battery module sample including center pins 55 was able to endure a higher degree of pressure than a battery module sample not including center pins 55.

As shown in FIG. 3, the center pins 55 may extend across the spacers 50 in the second direction Z2. A pair of the center pins 55 extending in parallel with each other may be provided for each of the spacers 50. The center pins 55 may not be deformed until a force having a certain value is applied to the center pins 55, so as to uniformly distribute a pressure concentrated on the center portions of the spacers 50 to the entire regions of the spacers 50. For example, if the center pins 55 are excessively bent, the center pins 55 may not properly function as load-distributing structures. For this reason, the center pins 55 may be provided as a pair or a plurality for each of the spacers 50 so as to reduce a load on each of the center pins 55. The number of the center pins 55 may be variously determined according to factors such as specifications of the battery cells 10 (e.g., charge capacity) and the sizes of the spacers 50. For example, two or more center pins 55 may be provided for each of the spacers 50.

The stopping jaws 55a may be formed on both ends of the center pins 55 for maintaining coupling between the center pins 55 and the spacers 50. That is, the stopping jaws 55a may be formed on both ends of the center pins 55 to prevent separation of the spacers 50 from the center pins 55.

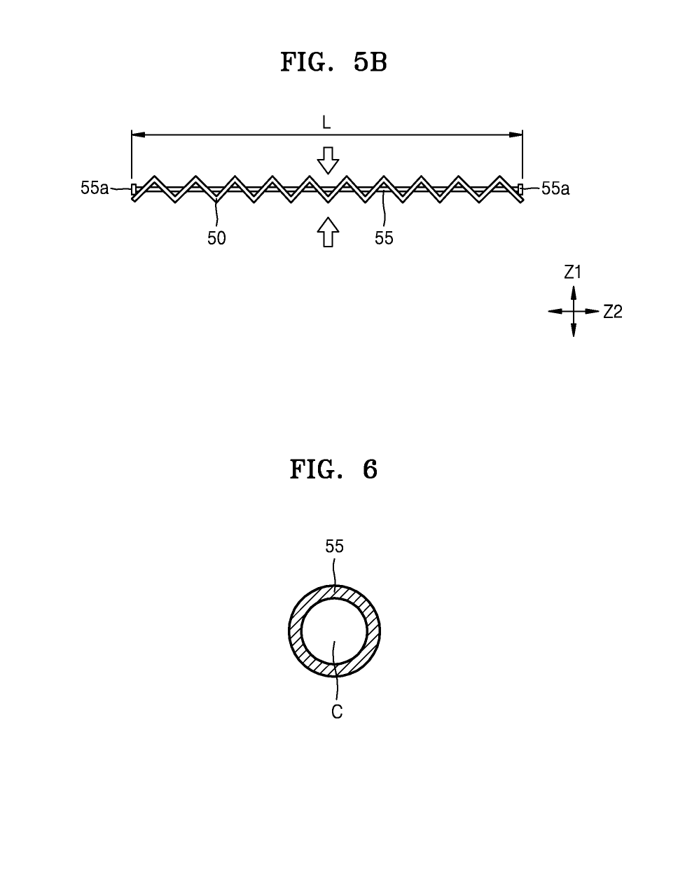

FIGS. 5A and 5B are views illustrating an initially assembled state in which a pressure is not applied to a spacer 50 and a pressed state in which a pressure is applied to the spacer 50. Referring to FIGS. 5A and 5B, stopping jaws 55a formed on both ends of a center pin 55 may determine a maximal deformation length L of the spacer 50. For example, the spacer 50 is not deformed to a length longer than the maximal deformation length L determined by the stopping jaws 55a. As shown in FIG. 5A, in an initially assembled state of the battery module 100, the battery cells 10 do not swell, and the spacers 50 (one is shown in FIG. 5A) are loosely disposed. In this state, there may be clearances between the spacers 50 and the stopping jaws 55a. That is, the spacers 50 may not be held against the stopping jaws 55a.

After a charging or discharging operation starts, the spacers 50 disposed between the battery cells 10 may be elastically deformed as the battery cells 10 swell. In this case, the spacers 50 are deformed while being spread in the second direction Z2. That is, the spacers 50 and the stopping jaws 55a may be brought into contact with each other without clearance therebetween as shown in FIG. 5B.

In the state shown in FIG. 5B, although the spacers 50 are further pressed, the spacers 50 are not further spread in the second direction Z2 due to the stopping jaws 55a formed on both ends of the center pins 55. However, in this state in which the maximal deformation lengths of the spacers 50 are limited to the value L, the spacers 50 may be elastically deformed according to a pressure applied in the first direction Z1. That is, although the spacers 50 are elastically deformed, the maximal deformation lengths of the spacers 50 are limited to the value L by the stopping jaws 55a formed on both ends of the center pins 55. Therefore, the spacers 50 may absorb a compressing force acting in the first direction Z1 while the spacers 50 are deformed in a state in which the lengths of the spacers 50 are not increased in the second direction Z2. For example, during the deformation of the spacers 50, the convex shapes of the spacers 50 may be changed from triangular shapes to rounded shapes. Then, after the compressing force is released, the shape of the spacers 50 may return or substantially return to the original shape thereof.

As described above, the spacers 50 may be deformed substantially in the same manner when the battery cells 10 swell or external pressure is applied to the battery module 100. For example, when a compressing pressure is applied to the battery module 100, the spacers 50 may be deformed while being spread in the second direction Z2 to absorb the compressing pressure.

FIG. 6 is a cross-sectional view illustrating the center pins 55 (one is shown). Referring to FIG. 6, the center pins 55 may be formed of hollow members. For example, the center pins 55 may have a hollow cylindrical shape having a ring-shaped cross-section. The center pins 55 may be inserted through penetration holes 50′ (refer to FIG. 3) of the spacers 50 in the second direction Z2, and may have a cylindrical shape not having a sharp portion to reduce friction with the spacers 50 around the penetration holes 50′.

The center pins 55 may be formed of hollow members in which cooling passages C (flow passages for a cooling medium) are formed, and thus a cooling medium such as ambient air may pass through the cooling passages C to cool the battery cells 10. For this, the center pins 55 may be formed of hollow members having both ends opened in the second direction Z2. Ambient air having a relatively low temperature may be introduced into the cooling passages C through ends of the center pins 55 and may exchange heat with the battery cells 10 while passing though the cooling passages C. Then, the ambient air may be discharged through the other ends of the center pins 55.

During charging and discharging operations of the battery cells 10, heat accumulated in the battery cells 10 may cause swelling of the battery cells 10. Therefore, the spacers 50 including a plurality of convex shapes are disposed between the battery cells 10 to form cooling medium flow spaces between the battery cells 10, and the center pins 55 having the cooling passages C are inserted through the spacers 50. As a result, the battery cells 10 may be more easily cooled, and thus swelling of the battery cells 10 may be prevented or reduced. If the battery cells 10 swell, pressure between the battery cells 10 may be increased to cause safety accidents such as explosions, and the charging and discharging characteristics of the battery cells 10 may be deteriorated due to deformation of the battery cells 10.

As shown in FIG. 1, the spacers 50 may be disposed on outer surfaces of the outermost battery cells 10 of the battery cells 10 in the arrangement direction (first direction Z1) of the battery cells 10 as well as being disposed between the battery cells 10. That is, the end plates 60 are disposed on both sides of the battery cells 10 in the arrangement direction (the first direction Z1) of the battery cells 10, and the spacers 50 may also be disposed between the end plates 60 and the outermost battery cells 10. In this case, a compressing force applied to inner battery cells 10 may be absorbed by spacers 50 disposed on both sides of the inner battery cells 10, and a compressing force applied to the outermost battery cells 10 may also be more effectively absorbed by spacers 50 disposed on both sides of the outermost battery cells 10.

In the current exemplary embodiment, the spacers 50 are disposed between the battery cells 10, and the center pins 55 are inserted in the spacers 50. However, in another exemplary embodiment, spacers 50 may be disposed between a plurality of battery modules 100, and center pins 55 may be inserted in the spacers 50. The former exemplary embodiment is provided in consideration of compression between neighboring battery cells 10, and the latter exemplary embodiment is provided in consideration of compression between neighboring battery modules 100. Although the exemplary embodiments are provided for different applications, the technical idea of using spacers 50 and inserting center pins 55 in the spacers 50 is substantially the same in the exemplary embodiments.

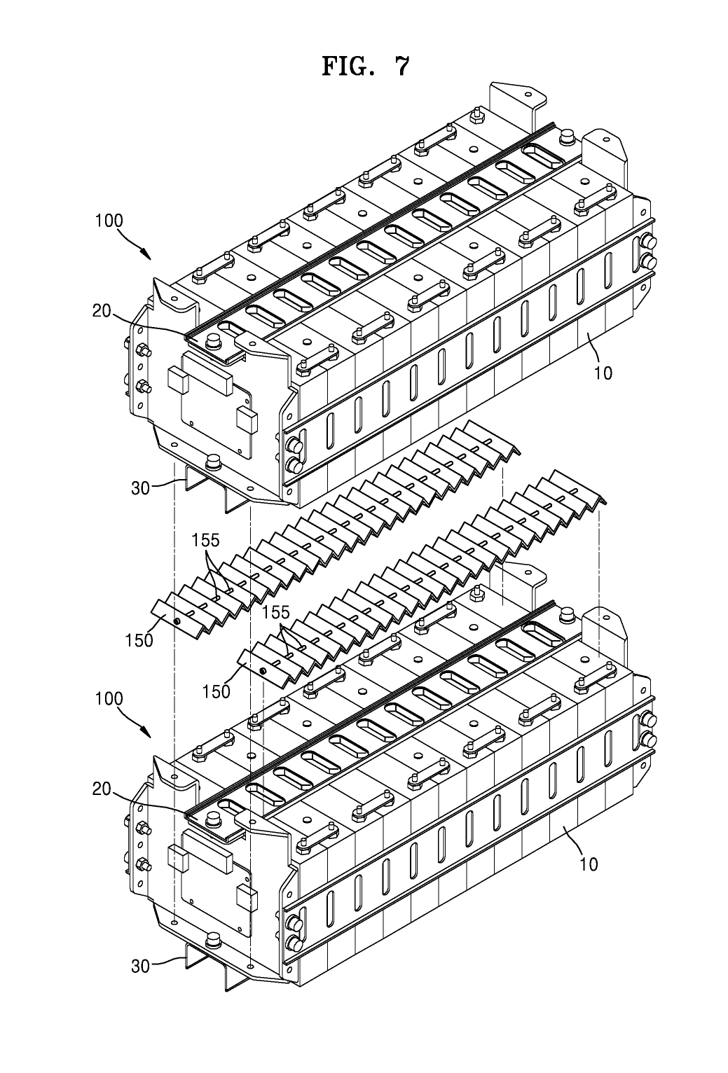

FIG. 7 is an exploded perspective view illustrating spacers 150 disposed between neighboring battery modules 100. Referring to FIG. 7, the spacers 150 are disposed between the battery modules 100 (upper and lower battery modules 100). In addition, center pins 155 are inserted through the spacers 150. The spacers 150 are disposed between the battery modules 100 each including a plurality of battery cells 10. In FIG. 7, the battery modules 100 are vertically arranged, and the spacers 150 are disposed between the upper battery module 100 and the lower battery module 100 to absorb a compressing force acting between the upper and lower battery modules 100.

In an assembled state, a lower plate 30 of the upper battery module 100 may be in contact with an upper plate 20 of the lower battery module 100 to form a duct through which gas generated from the battery cells 10 is discharged to the outside. Therefore, to prevent interference between the duct and the spacers 150, the spacers 150 may be disposed on left and right sides of a center region in which the upper plate 20 and the lower plate 30 are disposed to form the duct.

For example, the lower plate 30 of the upper battery module 100 and the upper plate 20 of the lower battery module 100 may be brought into contact with each other to form the duct, and the spacers 150 may be disposed on both sides of the duct, so as to reduce and absorb impacts between the upper battery module 100 and the lower battery module 100 when the upper battery module 100 wobbles left and right. In another exemplary embodiment, the spacers 150 may be disposed between battery modules 100 arranged left and right so as to reduce a compressing force acting therebetween.

As described above, an exemplary embodiment provides a battery module capable of more effectively absorbing external pressure or internal pressure caused by swelling and thus having a sufficient degree of stiffness against internal or external pressure.

Another exemplary embodiment provides a battery module having a heat-dissipating structure for more effectively dissipating heat generated during charging and discharging operations.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A battery module comprising:
battery cells arranged in a first direction;
a spacer disposed between neighboring battery cells; and
a center pin extending in a second direction that is different from the first direction and inserted through the spacer to cross the spacer.

2. The battery module of claim 1, wherein the spacer has a waveform pattern in which a plurality of convex or concave shapes are repeatedly arranged.

3. The battery module of claim 2, wherein the spacer has a triangular waveform pattern.

4. The secondary battery module of claim 1, wherein the second direction is perpendicular to the first direction.

5. The battery module of claim 1, wherein the spacer is formed of an elastic material.

6. The battery module of claim 5, wherein the spacer is formed of a metallic material.

7. The battery module of claim 1, wherein the spacer is elastically deformed while being spread in the second direction in response to a compressing force applied in the first direction, so as to absorb the compressing force applied in the first direction.

8. The battery module of claim 1, wherein the center pin is a hollow member in which a flow passage is formed for a cooling medium.

9. The battery module of claim 8, wherein the spacer has a hollow circular cross-section.

10. The battery module of claim 1, wherein the center pin comprises a pair of pins extending in parallel with each other.

11. The battery module of claim 1, wherein stopping jaws are formed on both ends of the center pin to prevent separation of the spacer from the center pin.

12. A battery module comprising
a plurality of battery cells arranged in a first direction having planar surfaces that extend in a second direction wherein the plurality of batteries are arranged such that the planar surfaces are positioned adjacent to each other;
a plurality of spacers interposed between adjacent planar surfaces of the plurality of batteries, wherein the plurality of spacers are expandable in the second direction in response to forces applied in the first direction; and
a restraining component that engages with the plurality of spacers so as to limit expansion of the plurality of spacers to a pre-selected amount.

13. The battery module of claim 12, wherein the restraining component comprises a plurality of center pins that are mounted in the spacers so as to extend across the spacers.

14. The battery pack of claim 13, wherein a plurality of center pins are mounted in each of the plurality of spacers.

15. The battery pack of claim 14, wherein the center pins are hollow to permit cooling medium to flow therethrough.

16. The battery pack of claim 13, wherein the ends of the plurality of center pins have flanged surfaces that engage with the ends of the spacers so as to inhibit the spacers from expanding more than the pre-selected amount.

17. The battery pack of claim 16, wherein the flanged surfaces comprise stopping jaws.

18. The battery pack of claim 12, wherein the plurality of spacers extend in the second direction and have repeating components that extend in the first direction that are compressed by pressure applied to the spacers.

19. The battery module of claim 18, wherein the plurality of spacers have a waveform pattern in which a plurality of convex or concave shapes are repeatedly arranged.

20. The battery module of claim 19, wherein the plurality of spacers have a triangular waveform pattern.
